(19) United States
(12) Patent Application Publication
(10) Pub. No.: US 2006/0089956 A1
(43) Pub. Date: Apr. 27, 2006

(54) Classification unit and methods thereof

(76) Inventors: Yaron M. Sadeh, Kfar Saba (IL); Roy Glasner, Ramat Gan (IL)

Correspondence Address: PEARL COHEN ZEDEK, LLP, 1500 BROADWAY 12TH FLOOR, NEW YORK, NY, 10036, US

(21) Appl. No.: 10/971,076

(22) Filed: Oct. 25, 2004

(51) Int. Cl. G06F 15/00

(52) U.S. Cl. 708/200

(57) ABSTRACT

A classification unit is to process an odd number of inputs in a single instruction cycle by comparing all distinct pairs of inputs and selecting one of the inputs based on the comparisons.

### BACKGROUND OF THE INVENTION

Non-linear filters are widely used in encoding and decoding algorithms for image and/or video. Such filters are used for noise reduction while maintaining image sharpness, for example. For example, a non-linear filter may process triplets of contiguous pixels and create a filtered image in which the middle pixel is replaced by the minimum, maximum or median of the three pixel values. For example, filtering a block of image data may involve processing successive triplets of pixels in columns of the image data (vertical filtering), followed by processing successive triplets of pixels in rows of the image data (horizontal filtering). A column of L pixels includes L-2 overlapping triplets of pixels. Similarly, a row of M pixels includes M-2 overlapping triplets of pixels.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an exemplary device including a processor coupled to a data memory and to a program memory, according to some embodiments of the invention;

FIG. 2 is a block diagram of an exemplary functional unit including an exemplary instance of a classification unit, according to an embodiment of the invention;

FIG. 3 is a block diagram of an exemplary functional unit including two exemplary instances of a classification unit, according to another embodiment of the invention; and

FIG. 4 is an illustration of a portion of an image, helpful in understanding some embodiments of the invention.

It will be appreciated that for simplicity and clarity of illustration, elements shown in the figures have not necessarily been drawn to scale For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

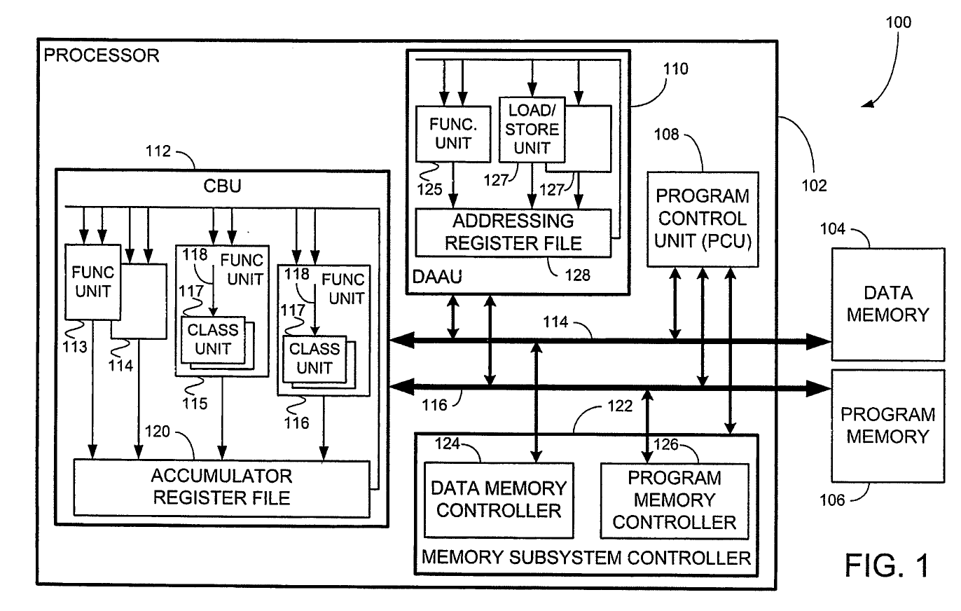

FIG. 1 is a block diagram of an exemplary apparatus 100 including a processor 102 coupled to a data memory 104 via a data memory bus 114 and to a program memory 106 via a program memory bus 116. Processor 102 may be a digital signal processor (DSP). Data memory 104 and program memory 106 may be the same memory. An exemplary architecture for processor 102 will now be described, although other architectures are also possible. Processor 102 includes a program control unit (PCU) 108, a data address and arithmetic unit (DAAU) 110, a computation and bit-manipulation unit (CBU) 112, and a memory subsystem controller 122. Memory subsystem controller 122 includes a data memory controller 124 coupled to data memory bus 114, and a program memory controller 126 coupled to program memory bus 116. PCU 108 is to retrieve, decode and dispatch machine language instructions and is responsible for the correct program flow. CBU 112 includes an accumulator register file 120 and functional units 113, 114, 115 and 116, having any of the following functionalities or combinations thereof: multiply-accumulate (MAC), add/subtract, bit manipulation, arithmetic logic, and general operations. Functional units 115 and 116 include one or more instances of a classification unit 117, which are described in more detail hereinbelow. DAAU 110 includes an addressing register file 128, load/store units 127 capable of loading and storing from/to data memory 104, and a functional unit 125 having arithmetic, logical and shift functionality.

Some machine language instructions may be executed by one or more instances of classification unit 117. The inputs and outputs of classification unit 117 are coupled to accumulator register file 120. (In other embodiments, functional units 115 and 116 may have fixed input registers and/or fixed output registers.)

In the example shown in FIG. 1, two functional units of processor 102 include one or more instances of a classification unit. In other embodiments of the invention, the processor may include a different number of functional units each having one or more instances of a classification unit. For example, the processor may include four or eight functional units each having one or more instances of a classification unit.

Processor 102 has an instruction set. A single machine language instruction from the instruction set is sufficient to instruct processor 102 to have an instance of classification unit 117 process N inputs, where N is an odd number greater than 1. For example, N may be three, five or seven, although larger odd numbers are also possible. An instruction cycle is the time period during which one machine language instruction is fetched from memory and executed. According to embodiments of the invention, in a single instruction cycle, a single instance of classification unit 117 is able to process a set of N inputs by comparing all distinct pairs of the N inputs and to select one of the N inputs. The selected input may be, for example, the minimum of the N inputs, or the median of the N inputs, or the maximum of the N inputs. Control signal(s) 118, which may be set by program control unit 108 or by functional unit 115/116 or both upon the decoding of a single machine language classification instruction, determine the relation by which an instance of classification unit 117 processes the inputs.

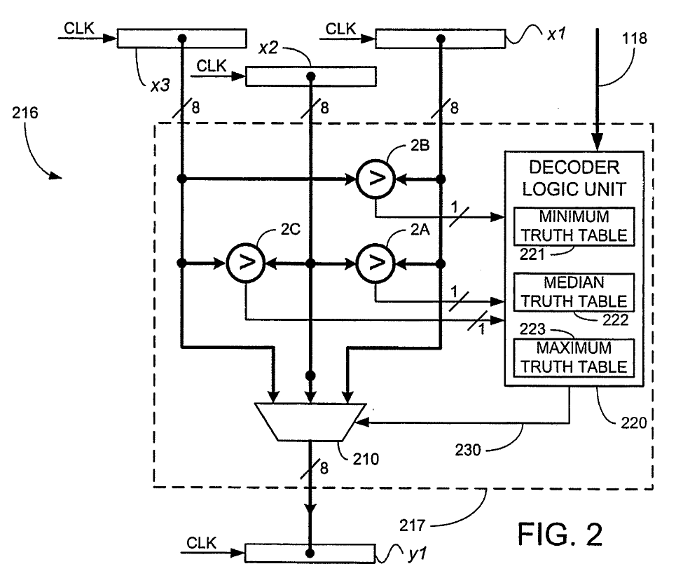

FIG. 2 is a block diagram of an exemplary functional unit 216 including an exemplary instance of a classification unit 217, according to an embodiment of the invention Classification unit 217 may have additional components, additional inputs and/or additional outputs that are not shown in order not to obscure the description of embodiments of the invention. In the example shown in FIG. 2, classification unit 217 is to process three inputs (N=3). In this example, the three inputs to classification unit 217, x1, x2 and x3, are fixed-point values of 8-bits width, and the output of classification unit 217, y1, is also a fixed-point value of 8-bits width. It is obvious to one of ordinary skill in the art how to modify classification unit 217 so that the inputs and output are values of a different width and/or are floating-point values.

The output y1 of classification unit 217 is one of inputs x1, x2, and x3. The value of control signal(s) 118 determines whether y1 is the minimum, median, or maximum of inputs x1, x2 and x3.

Classification unit 217 includes comparators 2A, 2B and 2C, a multiplexer 210, and a decoder logic unit 220. Each comparator receives two 8-bit inputs and produces a 1-bit output having a first value, say “1”, if its first input is exceeds its second input, and having a second value, say “0”, otherwise. (In other embodiments, each comparator may test whether its first input is greater than or equal to its second input.) Comparator 2A compares inputs x1 and x2, comparator 2B compares inputs x1 and x3, and comparator 2C compares inputs x2 and x3. In other words, each comparator of classification unit 217 compares a different pair of the three inputs.

Based on control signal(s) 118 and the outputs of comparators 2A, 2B and 2C, decoder logic unit 220 outputs selection signals 230 to control which input of multiplexer 210 is selected as its output. Multiplexer 210 receives as input x1, x2 and x3.

Decoder logic unit 220 includes a minimum truth table 221, a median truth table 222, and a maximum truth table 223:

TRUTH TABLES OF DECODER LOGIC UNIT 220

| Output of | | | | | |
|---|---|---|---|---|---|
| Comparator | | | Selection | | |
| 2A | 2B | 2C | MIN | MED | MAX |
| 0 | 0 | 0 | x1 | x2 | x3 |
| 0 | 0 | 1 | x1 | x3 | x2 |
| 0 | 1 | 0 | illegal combination | | |
| 0 | 1 | 1 | x3 | x1 | x2 |
| 1 | 0 | 0 | x2 | x1 | x3 |
| 1 | 0 | 1 | illegal combination | | |
| 1 | 1 | 0 | x2 | x3 | x1 |
| 1 | 1 | 1 | x3 | x2 | x1 |

Truth tables 221, 222 and 223 may be condensed into a single truth table without redundant entries.

Control signal(s) 118 determine which truth table, or which output of a truth table, is consulted by decoder logic unit 220 to generate output signals 230.

In other embodiments, each comparator may test whether its first input is less than its second input, or whether its first input is less than or equal to its second input. In such embodiments, the truth tables will be modified accordingly.

Classification unit 217 receives three inputs and produces one output. The three inputs may be received from one, two or three registers. The output may be stored in a register. The one or more register from which the inputs are received, and the register in which the output is stored, may be coupled to classification unit 217 through multiplexers or any other combinational logic. Due to timing considerations such as propagation delays inside classification unit 217 or due to any other reason, the purely combinatorial operation of classification unit 217 may be broken into sequential stages using pipeline registers (not shown) to capture intermediate results, and of course the original input registers and original output register. The placement of pipeline registers to store intermediate results within classification unit 217 is a matter of engineering design. Several such levels of pipeline registers may be added.

is obvious to a person of ordinary skill in the art how to modify classification unit 217 to process a single set of a different number of inputs in a single instruction cycle. In general,

$$\frac{N ( N - 1 )}{2}$$

comparators are needed to process a set of N inputs to find the minimum, median or maximum of the inputs. That amounts to one comparator for each distinct pair of inputs in the set of N inputs. For example, three comparators are needed to process a triplet of inputs, ten comparators are needed to process a quintuplet of inputs, and twenty-one comparators are needed to process a septuplet of inputs. In other words, a classification unit to process a set of N inputs, namely inputs x1 . . . xN, needs comparators to compare x1 with x2 through xN, comparators to compare x2 with x3 through xN, comparators to compare x3 with x4 through xN, etc. In general, a comparator is needed for each comparison between xi and xj, where index i runs from 1 to N−1 and index j runs from i+1 to N.

A functional unit may include multiple instances of a classification unit according to some embodiments of the invention. For example, a functional unit may have a first instance of a classification unit to process a first set of N inputs and a second instance of a classification unit to process a second set of N inputs having N−1 inputs in common with the first set. In another example, a functional unit may have three instances of a classification unit to process N+2 inputs in three overlapping sets of N inputs. In other examples, a functional unit may have even more instances of a classification unit.

According to some embodiments of the invention, a classification unit to process two sets of N inputs that overlap by all but a single input may include

$$\frac{N ( N - 1 )}{2} - 1$$

shared comparators to perform comparisons for both sets and N−1 comparators to perform comparisons for one or the other of the sets. It is obvious to a person of ordinary skill in the art how to build a classification unit to process more than two sets of N inputs having overlapping inputs according to embodiments of the invention.

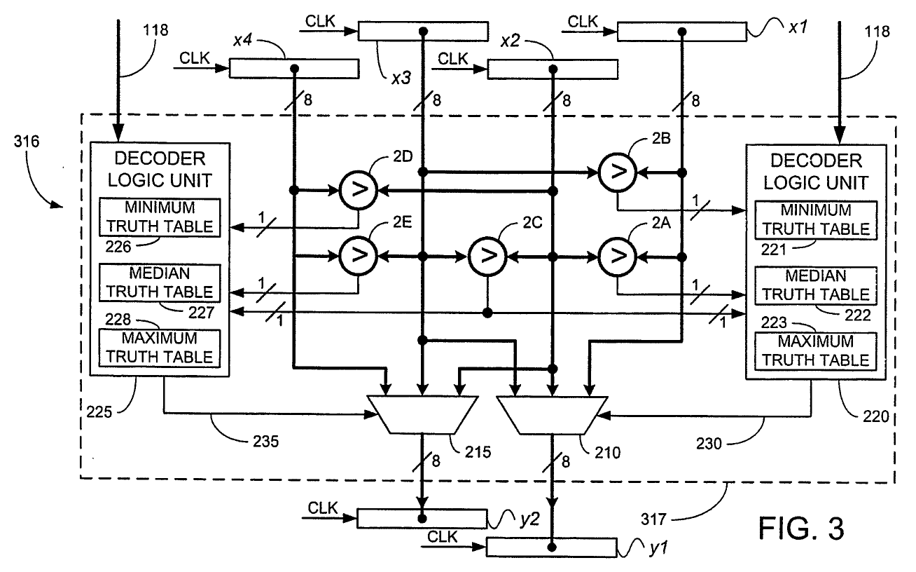

FIG. 3 is a block diagram of an exemplary functional unit 316 including a unit 317 having two instances of a classification unit, according to an embodiment of the invention. Unit 317 may have additional components, additional inputs and/or additional outputs that are not shown in order not to obscure the description of embodiments of the invention. In the example shown in FIG. 3, the four inputs to unit 317, x1, x2, x3 and x4, are fixed-point values of 8-bits width, and the two outputs of unit 317, y1 and y2, are also fixed-point values of 8-bits width. It is obvious to one of ordinary skill in the art how to modify unit 317 so that the inputs and outputs are values of a different width and/or are floating-point values.

The output y1 of unit 317 is one of inputs x1, x2, and x3. The output y2 of unit 317 is one of inputs x2, x3, and x4. The value of control signal(s) 118 determines whether y1 is the minimum, median, or maximum of inputs x1, x2 and x3, and whether y2 is the minimum, median or maximum of inputs x2, x3 and x4.

Unit 317 includes comparators 2A, 2B, 2C, 2D and 2E, multiplexers 210 and 215, two decoder logic units 220 and 225. Each comparator receives two 8-bit inputs and produces a 1-bit output having a first value, say “1”, if its first input is exceeds its second input, and having a second value, say “0”, otherwise. (In other embodiments, each comparator may test whether its first input is greater than or equal to its second input.) Comparator 2A compares inputs x1 and x2, comparator 2B compares inputs x1 and x3, comparator 2C compares inputs x2 and x3, comparator 2D compares inputs x2 and x4, and comparator 2E compares inputs x3 and x4.

Based on control signal(s) 118 and the outputs of comparators 2A, 2B and 2C, decoder logic unit 220 outputs selection signals 230 to control which input of multiplexer 210 is selected as its output. Similarly, based on control signal(s) 118 and the outputs of comparators 2C, 2D and 2E, decoder logic unit 225 outputs selection signals 235 to control which input of multiplexer 215 is selected as its output. Multiplexer 210 receives as input x1, x2 and x3, while multiplexer 215 receives as input x2, x3 and x4.

Decoder logic unit 220 includes minimum truth table 221, median truth table 222, and maximum truth table 223, as given hereinabove. Truth tables 221, 222 and 223 may be condensed into a single truth table without redundant entries.

Similarly decoder logic unit 225 includes a minimum truth table 226, a median truth table 227, and a maximum truth table 228:

TRUTH TABLES OF DECODER LOGIC UNIT 225

| Output of | | | | | |
|---|---|---|---|---|---|
| Comparator | | | Selection | | |
| 2C | 2D | 2E | MIN | MED | MAX |
| 0 | 0 | 0 | x2 | x3 | x4 |
| 0 | 0 | 1 | x2 | x4 | x3 |
| 0 | 1 | 0 | illegal combination | | |
| 0 | 1 | 1 | x4 | x2 | x3 |
| 1 | 0 | 0 | x3 | x2 | x4 |
| 1 | 0 | 1 | illegal combination | | |
| 1 | 1 | 0 | x3 | x4 | x2 |
| 1 | 1 | 1 | x4 | x3 | x2 |

Truth tables 226, 227 and 228 may be condensed into a single truth table without redundant entries.

Control signal(s) 118 determine which truth table, or which output of a truth table, is consulted by decoder logic units 220 and 225 to generate output signals 230 and 235, respectively

In other embodiments, each comparator may test whether its first input is less than its second input, or whether its first input is less than or equal to its second input. In such embodiments, the truth tables will be modified accordingly.

Decoder logic units 220 and 225 may be implemented as two instances of a single decoder. In other embodiments, decoder logic units 220 and 225 may be replaced by a single larger decoder logic unit.

Unit 317 receives four inputs and produces two outputs. The four inputs may be received from one, two, three or four registers. The outputs may be stored in one or two registers. The one or more registers from which the inputs are received, and the one or more registers in which the outputs are stored, may be coupled to unit 317 through multiplexers or any other combinatorial logic. Due to timing considerations such as propagation delays inside unit 317 or due to any other reason, the purely combinatorial operation of unit 317 may be broken into sequential stages using pipeline registers (not shown) to capture intermediate results, and of course the original input registers and original output registers. The placement of pipeline registers to store intermediate results within unit 317 is a matter of engineering design. Several such levels of pipeline registers may be added.

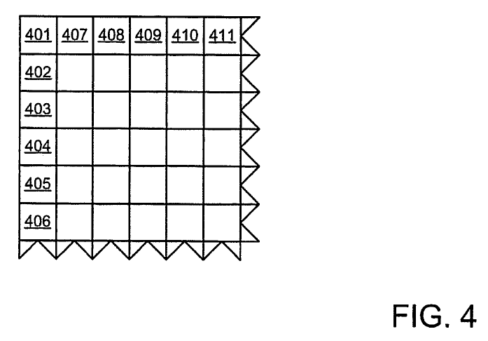

A portion of an image is shown in FIG. 4. One or more instances of classification units according to embodiments of the invention may be used to filter an image. Vertical filtering will begin by processing, in a single instruction cycle, the triplet of pixels 401, 402, and 403 to determine the vertically-filtered value of pixel 402, and the triplet of pixels 402, 403 and 404 to determine the vertically-filtered value of pixel 403. In a subsequent instruction cycle, the triplet of pixels 403, 404 and 405 will be processed to determine the vertically-filtered value of pixel 404 and the triplet of pixels 404, 405 and 406 will be processed to determine the vertically-filtered value of pixel 405.

Vertical filtering of the columns of the image may be followed by horizontal filtering. Horizontal filtering will begin by processing, in a single instruction cycle, the triplet of vertically-filtered pixels 401, 407, and 408 to determine the horizontally-filtered value of pixel 407, and the triplet of vertically-filtered pixels 407, 408 and 409 to determine the horizontally-filtered value of pixel 408. In a subsequent instruction cycle, the triplet of vertically-filtered pixels 408, 409 and 410 will be processed to determine the horizontally-filtered value of pixel 409 and the triplet of vertically-filtered pixels 409, 410 and 411 will be processed to determine the horizontally-filtered value of pixel 410.

Although the description hereinabove describes vertical filtering followed by horizontal filtering, other embodiments involve horizontal filtering followed by vertical filtering, or any other combination of vertical filtering and horizontal filtering.

According to embodiments of the invention, classification unit 117 enables four contiguous pixels to be processed in a single instruction cycle, for filtering according to the minimum, median or maximum of a triplet of pixels. For comparison, on a standard processor, capable of executing a single compare instruction per cycle, it would take at least 12 instruction cycles to perform the classification of two such triplets.

FIG. 1 shows that both functional units 115 and 116 include classification unit 117. Therefore, the classification unit of functional unit 115 may process four contiguous pixels in a single instruction cycle, and the classification unit of functional unit 116 may process another four contiguous pixels in the same instruction cycle. The four contiguous pixels processed by the classification unit of functional unit 115 may overlap the four contiguous pixels processed by the classification unit of functional unit 116. For example, in a single instruction cycle, the classification unit of functional unit 115 may process pixels 301, 302, 303 and 304 and the classification unit of functional unit 116 may process pixels 303, 304, 305 and 306. Alternatively, the four contiguous pixels processed by the classification unit of functional unit 115 may not overlap the four contiguous pixels processed by the classification unit of functional unit 116 and may even be from a different image.

Although embodiments of the invention have been described in the context of a processor, other embodiments of the invention include one or more instances of the classification unit described hereinabove in the context of other logic circuitry that are not processors. A non-exhaustive list of examples for logic circuitry that are not processors includes a field programmable gate array (FPGA), an application specific integrated circuit (ASIC), an application specific standard product (ASSP), a dedicated or stand-alone device and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A functional unit comprising:
a first instance of a classification unit to process N inputs, said classification unit including:
a comparator for each distinct pair of said inputs, each such comparator to produce an output that is a first value if a first input of said pair exceeds a second input of said pair and is a second value otherwise;
a decoder logic unit to receive said output from each said comparator and to output one or more selection signals; and
a multiplexer to receive said N inputs and to output a selected one of said N inputs according to said one or more selection signals,
wherein N is an odd number greater than 1.

2. The functional unit of claim 1, wherein said decoder logic unit is to receive one or more control signals that determine whether said classification unit is to select the minimum of said N inputs, the median of said N inputs, or the maximum of said N inputs.

3. The functional unit of claim 1, further comprising:
a second instance of said classification unit to process another input and N−1 of said N inputs.

4. The functional unit of claim 3, wherein one or more of said comparators of said first instance are shared by said second instance.

5. The functional unit of claim 3, wherein
$$\frac{N ( N - 1 )}{2} - 1$$
of said comparators of said first instance are shared by said second instance.

6. The functional unit of claim 3, further comprising:
one or more additional instances of said classification unit.

7. The functional unit of claim 1, wherein N is three.

8. The functional unit of claim 1, wherein N is five.

9. The functional unit of claim 1, wherein N is seven.

10. A processor comprising:
a program control unit to decode machine language instructions; and
a functional unit comprising:
a first instance of a classification unit to process N inputs, said classification unit including:
a comparator for each distinct pair of said inputs, each such comparator to produce an output that is a first value if a first input of said pair exceeds a second input of said pair and is a second value otherwise;
a decoder logic unit to receive said output from each said comparator and to output one or more selection signals; and
a multiplexer to receive said N inputs and to output a selected one of said N inputs according to said one or more selection signals,
wherein N is an odd number greater than 1.

11. The processor of claim 10, wherein said decoder logic unit is to receive one or more control signals that determine whether said classification unit is to select the minimum of said N inputs, the median of said N inputs, or the maximum of said N inputs.

12. The processor of claim 10, wherein said functional unit further comprises:
a second instance of said classification unit to process another input and N−1 of said N inputs.

13. The processor of claim 12, wherein one or more of said comparators of said first instance are shared by said second instance.

14. The processor of claim 12, wherein
$$\frac{N ( N - 1 )}{2} - 1$$
of said comparators of said first instance are shared by said second instance.

15. The processor of claim 12, wherein said functional unit further comprises:
one or more additional instances of said classification unit.

16. The processor of claim 10, wherein N is three.

17. The processor of claim 10, wherein N is five.

18. The processor of claim 10, wherein N is seven.

19. The processor of claim 10, further comprising:
another functional unit comprising:
one or more additional instances of said classification unit.

20. A method for filtering an image, the method comprising:
in a single instruction cycle:
performing comparisons of all distinct pairs of a first set of N contiguous pixels of said image; and
selecting, based on said comparisons, a pixel value of one of said first set as a filtered pixel value for the pixel at the center of said first set,
wherein N is an odd number greater than 1.

21. The method of claim 20, wherein said filtered pixel value is a minimum of values of pixels in said first set.

22. The method of claim 20, wherein said filtered pixel value is a median of values of pixels in said first set

23. The method of claim 20, wherein said filtered pixel value is a maximum of values of pixels in said first set.

24. The method of claim 23, further comprising:
in said single instruction cycle:
performing comparisons of all distinct pairs of a second set of N contiguous pixels of said image, said second set having N−1 contiguous pixels in common with said first set; and
selecting, based on said comparisons of all distinct pairs of said second set, a pixel value of one of said second set as a filtered pixel value for the pixel at the center of said second set.

25. The method of claim 20, wherein N is three.

26. The method of claim 20, wherein N is five.

27. The method of claim 20, wherein N is seven

28. A method comprising:
in a single instruction cycle, comparing all distinct pairs of a first set of N values and selecting a value from said first set,
wherein N is an odd number greater than 1.

29. The method of claim 28, further comprising:
in said single instruction cycle, comparing all distinct pairs of a second set of N values having N−1 values in common with said first set, and selecting a value from said second set.

30. The method of claim 28, wherein selecting said value includes selecting a minimum of said N values.

31. The method of claim 28, wherein selecting said value includes selecting a median of said N values.

32. The method of claim 28, wherein selecting said value includes selecting a maximum of said N values.

33. The method of claim 28, wherein N is three.

34. The method of claim 28, wherein N is five.

35. The method of claim 28, wherein N is seven.
